(19) United States
(12) Patent Application Publication
(10) Pub. No.: US 2024/0283167 A1
(43) Pub. Date: Aug. 22, 2024

(54) ANTENNA DEVICE AND COMMUNICATION SYSTEM

(71) Applicant: DKK Company, Limited, Chiyoda-ku, Tokyo (JP)

(72) Inventors: Keisuke SATO, Chiyoda-ku, Tokyo (JP); Yukitaka TAKAHASHI, Chiyoda-ku, Tokyo (JP); Susumu MIURA, Chiyoda-ku, Tokyo (JP); Toshiro KAWAHARA, Chiyoda-ku, Tokyo (JP)

(73) Assignee: DKK Company, Limited, Chiyoda-ku, Tokyo (JP)

(21) Appl. No.: 18/687,066

(22) PCT Filed: Aug. 24, 2022
(86) PCT No.: PCT/JP2022/031941

§ 371 Date: Feb. 27, 2024

(30) Foreign Application Priority Data
Aug. 30, 2021 (JP) 2021-140483

(51) Int. Cl. H01Q 21/10; H01Q 1/24; H01Q 3/22; H01Q 13/20

(52) U.S. Cl. CPC H01Q 21/10; H01Q 1/24; H01Q 3/22; H01Q 13/20

(57) ABSTRACT

The purpose of the present invention is to provide an antenna device capable of improving area quality by obtaining a good CN ratio using a high-gain antenna. This antenna device has a leaky wave antenna, a high-frequency unit, and a control unit. The leaky wave antenna has an element array. The element array has a plurality of unit elements disposed in series. The unit element has a capacitance unit and an inductance unit, and either the capacitance unit or the inductance unit is disposed in series with an adjacent other unit element. The control unit uses the beam squint of the leaky wave antenna to transmit radio waves in different directions for each of two or more different frequencies.

### TECHNICAL FIELD

The present invention relates to an antenna device using a leaky wave antenna, and a communication system having the antenna device.

### BACKGROUND ART

An example of beamforming is described in Patent Literature 1. In beamforming, multiple wireless devices, variable phase shifters, and variable attenuators are connected to a large number of antenna elements, and a high-gain beam is directed toward a terminal.

Frequency efficiency is high since beams in the same direction are obtained over the frequency band. Also, the high gain improves the carrier-to-noise (CN) ratio and provides good area quality.

When using a signal such as 28 GHz, there is a configuration in which a single radio device performs beamforming using only a phase shifter. In this configuration, a beam ID is set and beams are switched for each terminal on the time axis.

Furthermore, as described in Patent Literature 2, a leaky wave antenna can also be used in communication.

On the other hand, an electromagnetic wave irradiation device which squints a beam using an antenna reflector is described in Patent Literature 3.

### PRIOR ART

### Patent Literature

Patent Literature 1 Japanese Patent Laid-Open No. 2021-16077
Patent Literature 2 Japanese Patent No. 6345325
Patent Literature 3 Japanese Patent No. 3700005

### SUMMARY OF THE INVENTION

### Problems to be Solved by the Invention

In the configuration described in Patent Literature 1, the complicated device configuration for beamforming results in high cost.

Additionally, in a leaky wave antenna, the beam direction changes depending on the frequency. This is called beam squint.

A characteristic of leaky wave antennas is that when the frequency changes, the maximum direction of directivity changes due to beam squint.

Suppression of this beam squint is also being considered.

Especially when a left-handed line made of metamaterial is used, the influence of beam squint is significant.

Patent Literature 3 is originally based on circularly polarized waves, and it is difficult to use linearly polarized waves (see paragraph 0041 of Patent Literature 3), but even in the case of circularly polarized waves, it is necessary to use a sub-reflector or multiple mirror surfaces and make adjustments in order to change the amount of squint (see paragraph 0045 of Patent Literature 3), which results in complicated device configuration and high costs.

Therefore, an object of the present invention is
to provide an antenna device and a base station system that includes the antenna device, that can improve area quality by obtaining a good CN ratio using a high-gain antenna.

Another object of the present invention is to provide an antenna device and a base station system having the antenna device, that have high time efficiency by swinging a beam on the frequency axis.

Furthermore, it is an object of the present invention to provide an antenna device and a base station system including the antenna device that can perform communication without reducing frequency efficiency even when terminals are widely distributed.

### Means for Solving the Problems

In the present invention, new viewpoint different from the conventional one is applied such that the beam squint phenomenon due to the frequency of the leaky wave antenna is utilized for beam forming by taking advantage of the characteristic of being affected by beam squint.

In one example, a reference signal for monitoring the received power at the terminal is placed within the used frequency band such that frequency assignment to the terminal is performed based on the measured value.

An antenna device according to an embodiment of the present invention has a leaky wave antenna, a high-frequency unit, ant a control unit, the leaky wave antenna comprises an element row, the element row comprises a plurality of unit elements disposed in series, the unit element comprises a capacitance unit and an inductance unit, and either the capacitance unit or the inductance unit is disposed in series with an adjacent other unit element, the control unit is connected to the high-frequency unit and configured to control a directivity of a radio wave, the high frequency unit comprises a high frequency output unit, and the high frequency unit is connected to the leaky wave antenna, wherein, the control unit is configured to transmit a radio wave in different directions for each of two or more different frequencies by using beam squint of the leaky wave antenna.

In an antenna device according to an embodiment of the present invention, an angle at which a transmission range of radio waves viewed from the antenna device is 60 degrees or more, due to the beam squint of the leaky wave antenna.

In an antenna device according to an embodiment of the present invention, the leaky wave antenna is a left-handed leaky wave antenna comprising a metamaterial.

An antenna device according to an embodiment of the present invention has two mutually independent power feeding units at both ends of the element array.

In an antenna device according to an embodiment of the present invention, the leaky wave antenna is a dual-polarization antenna comprising two element rows and corresponding to two mutually orthogonal polarizations.

In an antenna device according to an embodiment of the present invention, the plurality of element rows are arranged in a direction substantially perpendicular to the direction of the beam squint to form an array, and the control unit is configured to transmit a radio wave in a direction of the beam squint and in a direction substantially perpendicular to the beam squint by controlling the beam squint and the plurality of element rows.

In an antenna device according to an embodiment of the present invention, the antenna device comprises a communication unit configured to transmit and receive communication signals to and from a communication terminal, and, the control unit is configured to transmit a radio wave in different directions for each of two or more different frequencies by using the beam squint of the leaky wave antenna.

In an antenna device according to an embodiment of the present invention, the communication signal includes a reference signal, the reference signal includes a monitor signal corresponding to two or more different frequencies, and the control unit is configured to control a directivity of the communication signal using the monitor signal.

In an antenna device according to an embodiment of the present invention, the communication terminal is a mobile terminal, and the reference signal is arranged within a demodulation reference symbol within a synchronization broadcast signal configured to be used in communication with the mobile terminal.

In an antenna device according to an embodiment of the present invention, the communication terminal is a mobile terminal, a synchronization notification signal used for communication with the mobile terminal is composed of different frequencies for each beam ID, the control unit is configured to assign one mobile terminal to one of two or more beam IDs, and the reference signal is placed within the synchronization notification signal used for communication with the mobile terminal.

In an antenna device according to an embodiment of the present invention, the communication terminal is a mobile terminal, a synchronization notification signal used for communication with the mobile terminal is time-divided for each beam ID, the control unit is configured to assign one mobile terminal to one of two or more beam IDs, and the reference signal is placed within the synchronization notification signal used for communication with the mobile terminal.

A communication system according to an embodiment of the present invention has the antenna device according to any one of the antenna devices described above.

### Effect of the Invention

With these configurations, the beam squint can be easily adjusted by simply changing the frequency without complicating the device configuration.

In communication, firstly, a high CN ratio can be obtained due to high antenna gain, making it possible to improve area quality. Second, swinging the beam along the frequency axis improves time efficiency. Third, if the terminals are widely distributed, the frequency efficiency is not reduced because the terminals can use all the frequency bands.

### BRIEF DESCRIPTION OF THE DRAWINGS

FIG. 1 shows a configuration example of an antenna device according to an embodiment of the present invention.

FIG. 2 shows a configuration example of an antenna device according to an embodiment of the present invention.

FIG. 3 shows a configuration example of an antenna device according to an embodiment of the present invention.

FIG. 4 shows a configuration example of an antenna device according to an embodiment of the present invention.

FIG. 5 shows a configuration example of an antenna device according to an embodiment of the present invention.

FIG. 6 shows a configuration example of an antenna device according to an embodiment of the present invention.

FIG. 7 shows a configuration example of an antenna device according to an embodiment of the present invention.

FIG. 8 shows a configuration example of an antenna device according to an embodiment of the present invention.

FIG. 9 shows a configuration example of an antenna device according to an embodiment of the present invention.

FIG. 10 shows a configuration example of an antenna device according to an embodiment of the present invention.

FIG. 11 shows a configuration example of a communication signal in an embodiment of the present invention.

FIG. 12 shows a configuration example of a communication signal in an embodiment of the present invention.

FIG. 13 shows an example of the configuration of a communication signal in an embodiment of the present invention.

FIG. 14 shows an example of the configuration of a communication system in an embodiment of the present invention.

FIG. 15 shows an example of the configuration of a communication system in an embodiment of the present invention.

### DETAILED DESCRIPTION

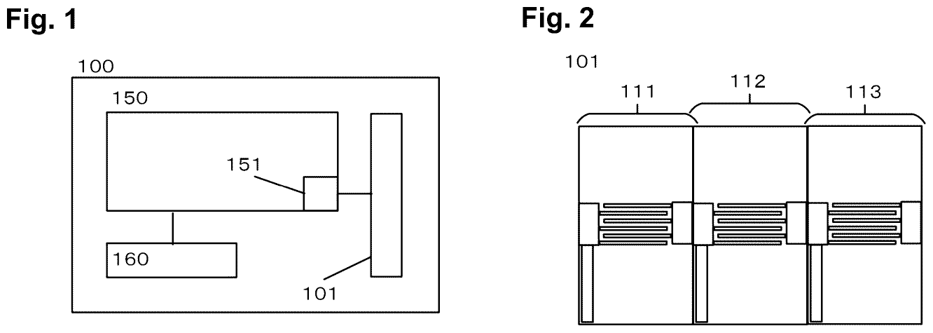

FIG. 1 shows a configuration example of an antenna device 100 according to an embodiment of the present invention.

As shown in FIG. 1, the antenna device 100 includes a leaky wave antenna 101, a high frequency unit 150, and a control unit 160.

The high frequency unit 150 has a high frequency output unit 151. The high frequency output unit 151 is connected to the leaky wave antenna 101.

The control unit 160 is connected to the high frequency unit 150 and controls the directivity of radio waves.

As shown in FIG. 2, the leaky wave antenna 101 has an element array 110.

The element row 110 has a plurality of unit elements 111, 112, and 113 arranged in series. Though three unit elements are shown in FIG. 2, as will be easily understood by those skilled in the art, the element array 110 may have other than three unit elements, and may have tens to hundreds of unit elements.

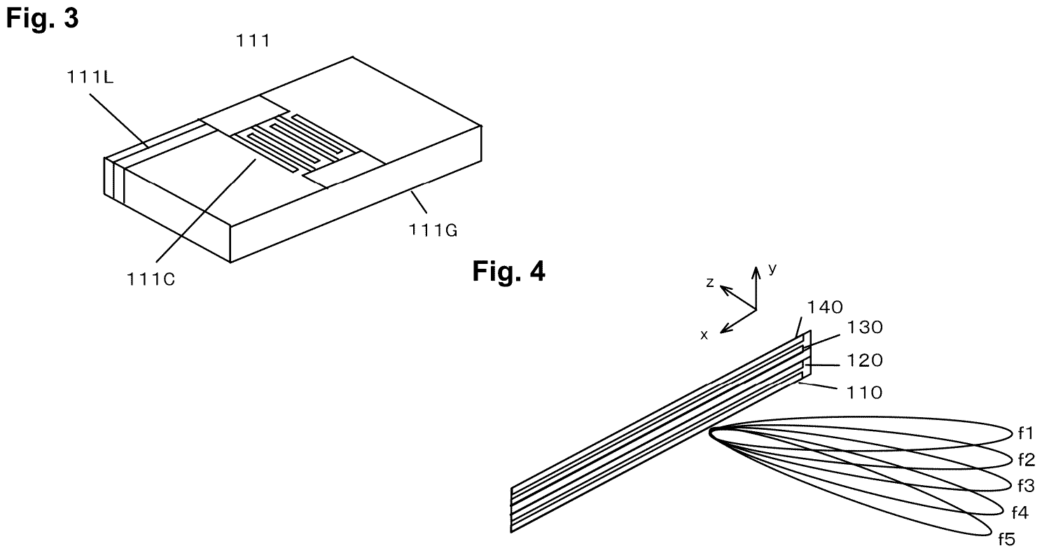

As shown in FIG. 3, the unit element 111 has a capacitance unit 111C and an inductance unit 111L. Either one of the capacitance unit 111C and the inductance unit 111L is arranged in series with another adjacent unit element 112.

As shown in FIG. 4, the control unit 160 uses the beam squint of the leaky wave antenna 101 to transmit radio waves in different directions at two or more different frequencies.

Specifically, radio waves are transmitted in different directions corresponding to each of frequencies f1, f2, f3, f4, and f5.

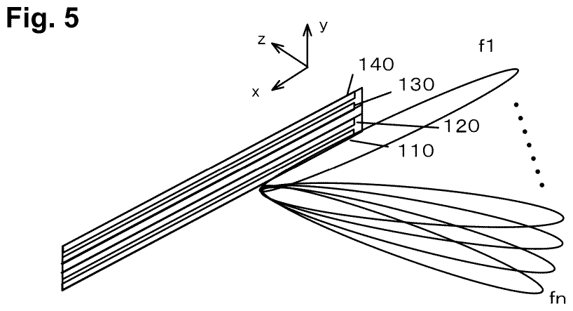

FIG. 5 shows a configuration example of an antenna device 100 in an embodiment of the present invention.

The angle at which the radio wave transmission range from the antenna device 100 is viewed is 60 degrees or more by using the beam squint of the leaky wave antenna 101.

Specifically, the transmission direction or reception direction of the radio wave corresponding to frequency f1 and the transmission direction or reception direction of the radio wave corresponding to frequency fn are different by 60 degrees or more.

In an embodiment, the leaky wave antenna 101 is a left-handed leaky wave antenna having a metamaterial 103.

By using metamaterials, it is possible to widen the angular range of the beam squint when the frequency band is constant.

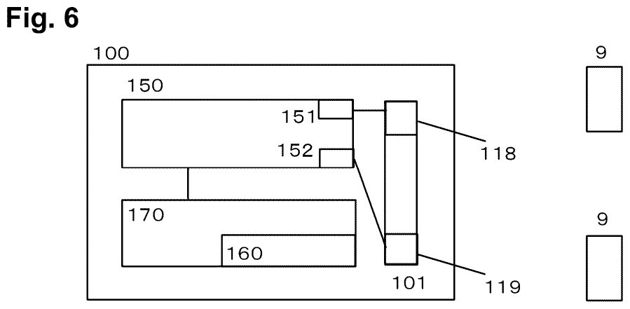

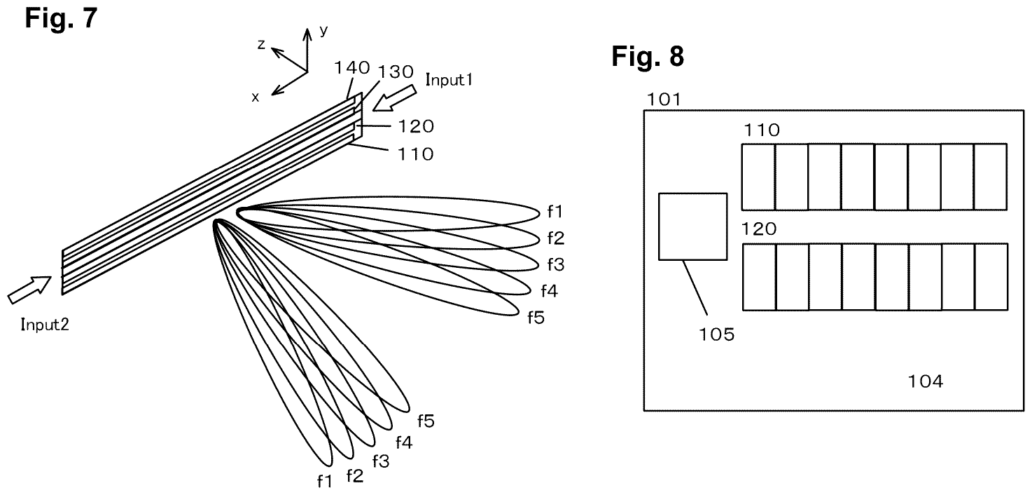

FIGS. 6 and 7 show a configuration example of an antenna device 100 in one embodiment of the present invention.

The antenna device 100 has two mutually independent power feeding units 118 and 119 at both ends of the element arrays 110, 120, 130, and 140, respectively. In this embodiment, the antenna device 100 has a communication unit 170, and the control section 160 is provided within the communication unit 170. Further, the leaky wave antenna is arranged on the XY plane, and the element arrays 110, 120, 130, and 140 are arranged in the X direction.

Specifically, the high frequency section 150 has two high frequency output units 151 and 152, that are respectively connected to the two power feeding units 118 and 119 provided at both ends of the element arrays 110, 120, 130, 140 of the leaky wave antenna 101.

When power is supplied from Input 1 of the power supply unit 118, the beam squint changes from the negative direction of the z-axis, that is, the negative z-axis direction, to the negative direction of the x-axis, that is, the negative x-axis direction, as the frequency goes from high to low.

When power is supplied from Input 2 of the power supply unit 119, the beam squint changes from the negative direction of the z-axis, that is, the negative z-axis direction, to the positive direction of the x-axis, that is, the positive x-axis direction, as the frequency goes from high to low.

In this way, by setting antenna feeding points in both directions, radio waves can be transmitted to both left and right sides in the front direction of the antenna, and for example, when used for communication, both left and right sides in the front direction of the antenna can be made into areas.

FIG. 8 particularly shows a configuration example of a leaky wave antenna 101 of an antenna device 100 in an embodiment of the present invention.

In this embodiment, two element rows 110 and 120 are formed on the substrate 104 and connected to the hybrid circuit section 105. By using hybrid circuits, two polarized waves can be used. By using two orthogonal polarized waves, for example, when used for communication, the number of lines can be doubled.

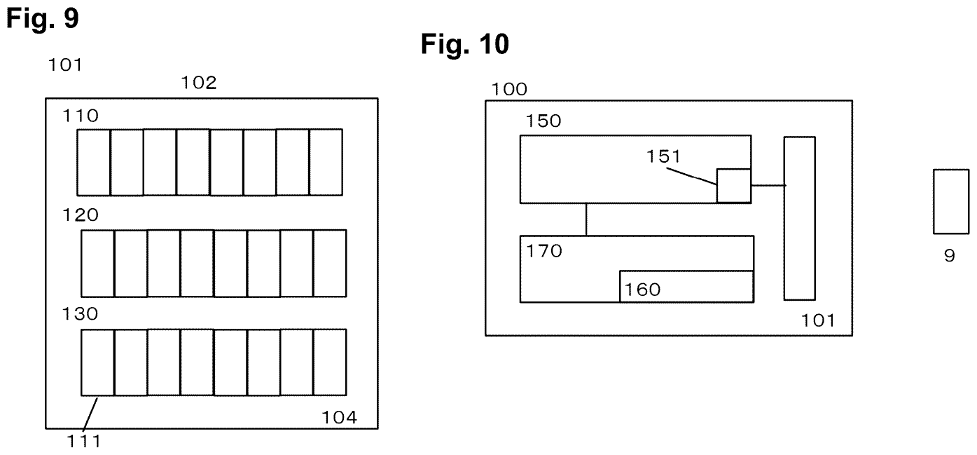

FIG. 9 particularly shows a configuration example of a leaky wave antenna 101 of an antenna device 100 in an embodiment of the present invention.

The leaky wave antenna 101 has a plurality of element rows 110, 120, and 130.

A plurality of element rows 110, 120, and 130 are arranged in a direction substantially perpendicular to the direction of the beam squint to form an array 102.

The control unit 160 transmits radio waves in the direction of the beam squint and in a direction substantially orthogonal to the beam squint by controlling the beam squint and the plurality of element arrays 110, 120, and 130.

In this embodiment, the array is arranged in a direction orthogonal to the beam squint of the leaky wave antenna 101, and beam control in the orthogonal direction is also possible. Furthermore, when used for communication for example, antenna gain is improved.

FIG. 10 shows a configuration example of an antenna device 100 in an embodiment of the present invention.

In this embodiment, the antenna device 100 includes a communication unit 170 that transmits and receives communication signals to and from a communication terminal 9 such as a mobile terminal.

The control unit 160 uses the beam squint of the leaky wave antenna 101 to transmit communication signals in different directions at two or more different frequencies.

Referring to FIG. 4, an example of beam squinting at five different frequencies f1 to f5 is considered.

When reference signals corresponding to f1 to f5 are used to measure the downlink reception power of a terminal, for example, for a terminal in an area corresponding to f1, the signal will have a high level at frequencies near f1, and will be weak at frequencies from f2 to f5. Allocation of frequencies using these values enables selection of the optimal beam for the terminal.

As will be easily understood by those skilled in the art, any number of frequencies may be used in practice, or a configuration may be employed in which appropriate frequencies are individually selected from continuously changing frequencies.

In an embodiment, the antenna device 100 includes a reference signal within the communication signal. In addition to that, the reference signal includes monitor signals corresponding to two or more different frequencies.

Then, the control unit 160 controls the directivity of the communication signal using the monitor signal.

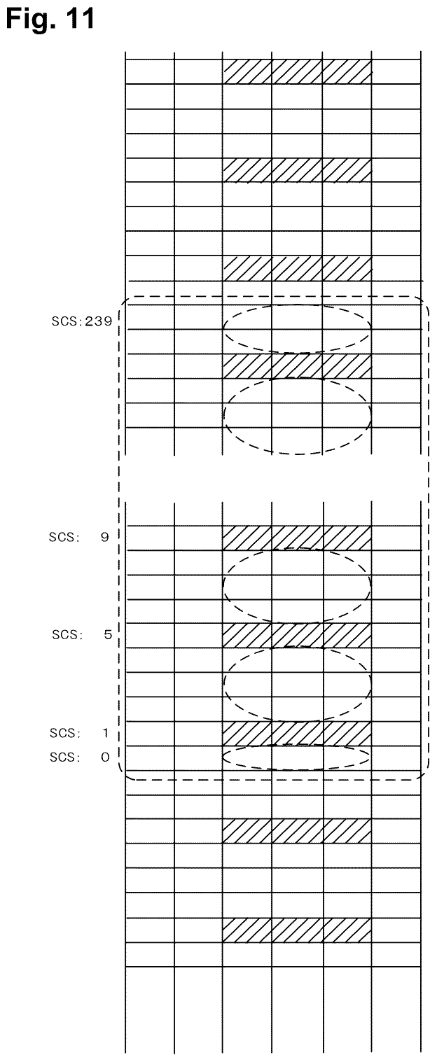

FIG. 11 shows an example of a configuration of a communication signal in an embodiment of the present invention.

The part surrounded by the substantially rectangular dashed line is the basic structure of SS/PBCH, corresponding to 240 SCS. Further, only demodulation reference symbols, that is, DMRS blocks, are arranged in all frequency bands. In other words, all frequencies are used.

The communication terminal 9 is a mobile terminal. The reference signal is arranged within a demodulation reference symbol within a synchronization broadcast signal used in communication with a mobile terminal.

In this way, the demodulation reference symbol in the synchronization broadcast signal used in communication with the mobile terminal includes the reference signal.

In this embodiment, the SS/PBCH applied in the mobile phone system, that is, the DMRS block arranged in the synchronization/broadcast signal, is used as the reference signal. In other words, the DMRS block includes a reference signal.

SS/PBCH is a downlink signal block used in 5G for synchronization/broadcasting between terminals and base stations.

Since it is composed of 240 subcarriers (hereinafter, they may be abbreviated as SC), the bandwidth changes depending on the subcarrier interval. For example, 240SC=15 kHz×240=3.6 MHz in a case where the subcarrier spacing is 15 kHz, 240SC=30×240=7.2 MHz in a case where the subcarrier spacing is 30 kHz, and 240SC=240×240=57.6 MHz in a case where the subcarrier spacing is 240 KHz.

However, in the conventional SS/PBCH, 240SC uses only a part of the available frequency band.

For example, in the case of the Sub6 band, the maximum bandwidth of SS/PBCH is usually 7.2 MHz within the 100 MHz usage band, but in this embodiment, only the DMRS blocks are allocated over the usage frequency band, that is, 100 MHz. In other words, the configuration makes use of 100 MHz of the available frequency band only in the DMRS blocks.

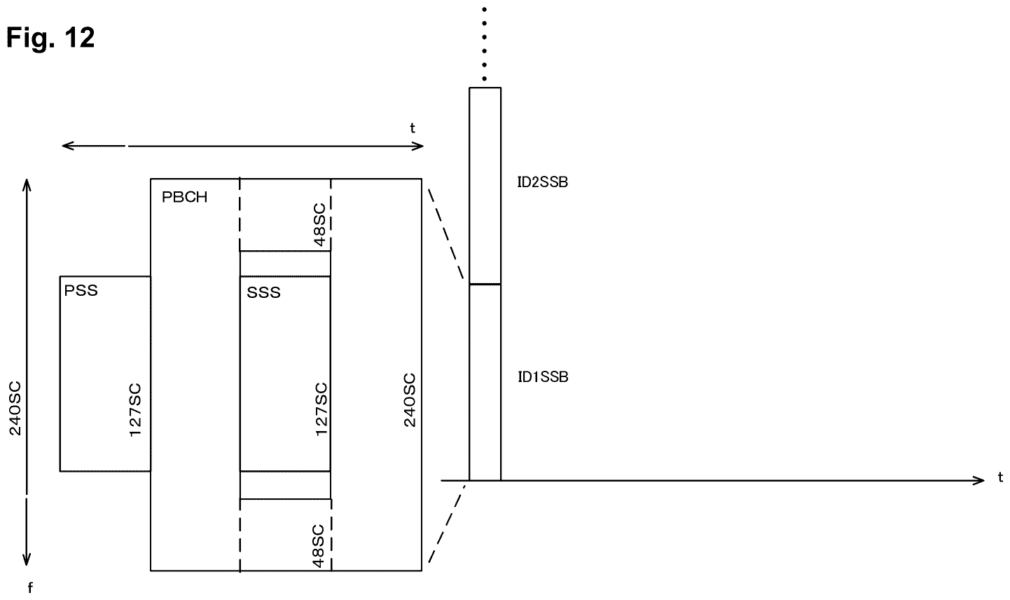

FIG. 12 shows an example of the configuration of a communication signal in an embodiment of the present invention.

In this embodiment, SSB blocks, which were conventionally set on the time axis, are allocated on the frequency axis, not being limited to DMRS blocks. Specifically, on the right side of the figure, the SSB block of beam ID1 (ID1SSB) and the SSB block of beam ID2 (ID2SSB) are arranged in this order in the frequency axis direction of the vertical axis. Then, in each beam, synchronous power measurement is performed using SS/PBCH.

The communication terminal 9 is a mobile terminal.

A synchronization notification signal used for communication with a mobile terminal is configured with a different frequency for each beam ID.

The control unit 160 assigns one mobile terminal to one of two or more beam IDs.

The reference signal is arranged in the synchronization broadcast signal used in communication with the mobile terminal.

Then, ID1SSB, which is the SSB block of beam ID1, and ID2SSB, which is the SSB block of beam ID2, are transmitted at the same time and at frequencies matched to their respective transmission directions.

This configuration enables assignment to each terminal to be carried out under the conventional beam selection rules by simply changing the conventional assignment on the time axis to the frequency axis.

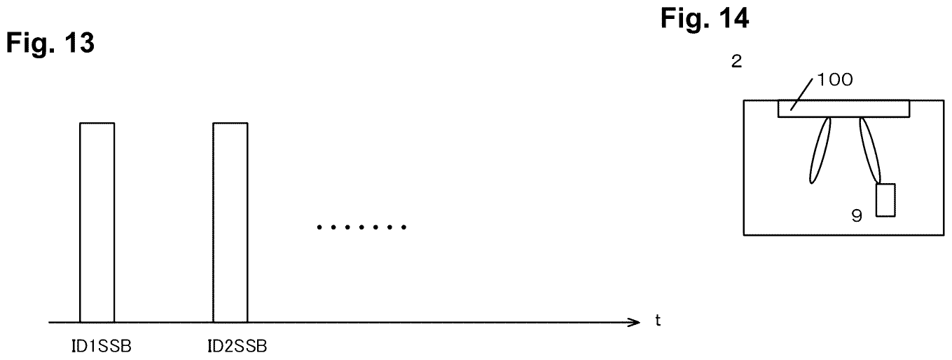

FIG. 13 shows an example of a configuration of a communication signal in an embodiment of the present invention.

In this embodiment, an SSB block is transmitted on the time axis for each beam ID on the SS/PBCH. In other words, the beamforming conditions are changed over time and a beam ID is assigned to each terminal.

The communication terminal 9 is a mobile terminal.

A synchronization broadcast signal used in communication with a mobile terminal is time-divided for each beam ID.

The control unit 160 assigns one mobile terminal to one of two or more beam IDs.

The reference signal is arranged in the synchronization broadcast signal used in communication with the mobile terminal.

Then, ID1SSB, which is the SSB block of beam ID1, and ID2SSB, which is the SSB block of beam ID2, are transmitted at different times and at frequencies matched to their respective transmission directions.

FIG. 14 shows an example of a configuration of a base station system, which is the communication system 2 in an embodiment of the present invention.

The communication system 2 includes any of the antenna devices 100 described above.

In this embodiment, a TDD system is used, and the frequency bands for transmission and reception are the same. If the frequency bands for transmission and reception are the same, a full-duplex communication system can be implemented.

Here, the communication signal uses a multicarrier modulation signal such as OFDM.

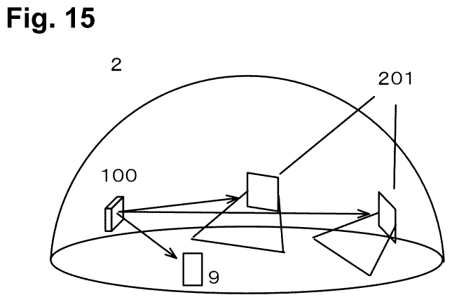

FIG. 15 shows another configuration example of a communication system 2 in an embodiment of the present invention.

Due to its configuration, the above-mentioned communication system 2 becomes an efficient communication system 2 even in a situation where terminals are evenly distributed in a wide-angle area such as a stadium or a metropolitan station platform.

As shown in FIG. 15, the communication area may be further expanded using reflect arrays 201 or the like.

According to the above configuration, firstly, a high CN ratio can be obtained due to the high antenna gain, realizing improvement of the area quality. Second, when the beam is swung along the frequency axis, time efficiency is improved. Third, if the terminals are widely distributed, the frequency efficiency will not be reduced because the terminals can make use of all the frequency bands.

It goes without saying that the present invention is not limited to the above embodiments, but the present invention includes various embodiments without departing from the spirit of the present invention.

For example, the communication system includes not only a base station system but also a mobile communication system mounted on a mobile body.

The targets to which the communication system transmits or receives radio waves for communication are not limited to communication terminals, and the targets may include other base stations and the like.

### EXPLANATION OF REFERENCE NUMERALS

100 antenna device
101 leaky wave antenna
102 array
103 metamaterial
104 substrate
105 hybrid circuit section
110, 120, 130, 140 element row 2
111, 112, 113 unit element
111C capacitance unit
111L inductance unit
111G ground unit
118,119 power supply unit
150 high frequency unit
151, 152 high frequency output unit
160 control unit
170 communication unit
2 communication system
201 reflect array
9 communication terminal

1. An antenna device comprising:
a leaky wave antenna, a high-frequency unit, and a control unit, wherein
the leaky wave antenna comprises an element row, the element row comprises a plurality of unit elements disposed in series, the unit element comprises a capacitance unit and an inductance unit, and either the capacitance unit or the inductance unit is disposed in series with an adjacent other unit element,
the control unit is connected to the high-frequency unit and configured to control a directivity of a radio wave,
the high frequency unit comprises a high frequency output unit, and
the high frequency unit is connected to the leaky wave antenna, wherein,
the control unit is configured to transmit a radio wave in different directions for each of two or more different frequencies by using beam squint of the leaky wave antenna.

2. The antenna device according to claim 1, wherein an angle at which a transmission range of radio waves viewed from the antenna device is 60 degrees or more, due to the beam squint of the leaky wave antenna.

3. The antenna device according to claim 1, wherein the leaky wave antenna is a left-handed leaky wave antenna comprising a metamaterial.

4. The antenna device according to claim 1, comprising two mutually independent power feeding units at both ends of the element array.

5. The antenna device according to claim 1, wherein the leaky wave antenna is a dual-polarization antenna comprising two element rows and corresponding to two mutually orthogonal polarizations.

6. The antenna device according to claim 1, wherein
the plurality of element rows are arranged in a direction substantially perpendicular to the direction of the beam squint to form an array, and
the control unit is configured to transmit a radio wave in a direction of the beam squint and in a direction substantially perpendicular to the beam squint by controlling the beam squint and the plurality of element rows.

7. The antenna device according to claim 1, wherein
the antenna device comprises a communication unit configured to transmit and receive communication signals to and from a communication terminal, and,
the control unit is configured to transmit a radio wave in different directions for each of two or more different frequencies by using the beam squint of the leaky wave antenna.

8. The antenna device according to claim 7, wherein
the communication signal includes a reference signal,
the reference signal includes a monitor signal corresponding to two or more different frequencies, and
the control unit is configured to control a directivity of the communication signal using the monitor signal.

9. The antenna device according to claim 8, wherein
the communication terminal is a mobile terminal, and
the reference signal is arranged within a demodulation reference symbol within a synchronization broadcast signal configured to be used in communication with the mobile terminal.

10. The antenna device according to claim 8, wherein
the communication terminal is a mobile terminal,
a synchronization notification signal used for communication with the mobile terminal is composed of different frequencies for each beam ID,
the control unit is configured to assign one mobile terminal to one of two or more beam IDs, and
the reference signal is placed within the synchronization notification signal used for communication with the mobile terminal.

11. The antenna device according to claim 8, wherein
the communication terminal is a mobile terminal,
a synchronization notification signal used for communication with the mobile terminal is time-divided for each beam ID,
the control unit is configured to assign one mobile terminal to one of two or more beam IDs, and
the reference signal is placed within the synchronization notification signal used for communication with the mobile terminal.

12. A communication system comprising the antenna device according to claim 7.
